(19) United States
(12) Patent Application Publication
(10) Pub. No.: US 2011/0258039 A1
(43) Pub. Date: Oct. 20, 2011

(54) EVALUATING PREFERENCES OF USERS ENGAGING WITH ADVERTISEMENTS

(75) Inventors: PRITESH PATWA, REDMOND, WA (US); WOOK CHUNG, KIRKLAND, WA (US); MARTIN MARKOV, BELLEVUE, WA (US)

(73) Assignee: MICROSOFT CORPORATION, REDMOND, WA (US)

(21) Appl. No.: 12/759,966

(22) Filed: Apr. 14, 2010

(51) Int. Cl. G06Q 30/00

(52) U.S. Cl. 705/14.45; 705/14.4; 705/14.53; 705/14.41

(57) ABSTRACT

Embodiments of the present invention relate to systems, methods, and computer-storage media for providing a method of evaluating preferences of particular users with respect to engaging with advertisements. In one embodiment, advertisements are delivered to users based on user engagement with advertisements. In particular, a request is received from an advertiser to present an advertisement to a set of users meeting a threshold user engagement level. After evaluating user engagement levels of the set of users, a subset of the set of users meeting the threshold user engagement level is determined. The advertisement is then presented to the subset of users.

### BACKGROUND

Advertisements are a significant source of revenue for companies that host website platforms. Thus, in arrangements where a company is paid each time a user clicks an advertisement, it is beneficial for the company to know which advertisements are most effective at securing user clicks. However, the number of times an advertisement is clicked is influenced by the preferences of the users to whom the advertisement is exposed. Thus, a high or low click-rate may be attributable more to particular user preferences than to overall, global effectiveness of the advertisement.

### SUMMARY

This Summary is provided to introduce a selection of concepts in a simplified form that are further described below in the Detailed Description. This Summary is not intended to identify essential features of the claimed subject matter, nor is it intended to be used as an aid in isolation to determine the scope of the claimed subject matter. Embodiments of the present invention provide methods for analyzing user interactions with advertisements. In particular, methods are provided for evaluating particular user preferences with respect to engaging with advertisements.

Advertisements are a significant source of revenue for hosts of web platforms. Many advertising pricing schemes are based on a pay-per-click model, where an advertiser pays an advertisement platform host an agreed-upon price each time a user selects or clicks on a presented advertisement. After a user selects or clicks on a presented advertisement, the user is presented with a webpage associated with the advertisement. Advertising pricing schemes may also be based on a pay-per-conversion model, where an advertiser pays an advertisement platform host an agreed-upon price each time a user initiates a transaction with a website associated with an advertisement. As such, it is in the best interest of the advertisement platform host to provide advertisements that are likely to be selected by the users to whom they are shown.

Towards this goal, advertisement platform hosts generally measure the effectiveness of an advertisement based on the number of times an advertisement is clicked when compared to the number of impressions that have been shown of the advertisement. An impression is the term used to indicate when an advertisement has been presented to a user. Each impression is then tracked to determine whether the advertisement was clicked, and if so, if there was a conversion. A conversion refers to a desired transaction with a webpage associated with the advertisement. A conversion may indicate purchasing an item, registering with the website, signing up for a bank account, initiating play of a video, or other interaction of the user with the website. Alternatively, a conversion may be a lack of interaction, such as when the website associated with the advertisement presents the user with a screen saying “Click this button if you would like to leave this site.”

For a new advertisement, it generally takes thousands of impressions before an accurate p-click is able to be calculated for an advertisement. For instance, when the engagement preferences of a user are not taken into account, it may take 70,000 impressions of an advertisement before an accurate p-click is determined for that advertisement. In other words, if an ineffective advertisement is evaluated, it may take 70,000 impressions before the advertisement is determined to be ineffective. During that trial period of determining the p-click for the ineffective advertisement, however, other advertisements that have been proven to be effective may be displaced. By increasing the effectiveness of p-click calculations, the number of impressions required to determine an accurate p-click may be significantly decreased. For example, if more accurate p-click calculations bring the threshold number of impressions down from 70,000 to 7,000, then advertisements that have been proven effective in securing user clicks, conversions, or both, may be more frequently presented to users.

As discussed above, methods of measuring the effectiveness of an advertisement that do not consider the engagement preferences of the particular users to whom an advertisement is presented may be inefficient. In particular, such methods run the risk of having data skewed not by actual effectiveness of the advertisement but by user-specific preferences. Aspects of the present invention discuss the influence of the user engagement preferences on the accuracy of an effectiveness measure associated with advertisements. In particular, aspects of the present invention discuss the influence of user engagement preferences on advertisement effectiveness measures that are click-based, conversion-based, or a combination or the two.

It is also in the best interest of an advertiser to have its advertisement selected by users who are most likely to engage in a transaction as a result of viewing the advertisement. For this reason, advertisers generally specify demographics of the end users to whom it wishes to present an advertisement. For instance, an advertiser of women's shoes may request that its advertisements be presented to women ages 18-50. However, beyond demographic influences, advertisers may wish to target advertisements based on user preferences of engaging with advertisements. For example, advertisers may want to target advertisements to consumers who have a strong preference to engage with webpages, particularly webpages associated with advertisements. As such, additional aspects of the present invention relate to evaluating the preferences of particular users with respect to engaging with advertisements.

In another example, some users within a target demographic spectrum, such as women ages 18-50 as discussed above, may have a strong preference against making online purchases. Although some women aged 18-50 who have a preference against making online purchases may enjoy buying shoes, an online shoe advertiser may wish to devote its marketing resources to women who have already made at least one online purchase. Thus, further aspects of the present invention relate to targeting advertisements to users based on the preferences of the users with respect to engaging with advertisements.

### BRIEF DESCRIPTION OF THE SEVERAL VIEWS OF THE DRAWINGS

Illustrative embodiments of the present invention are described in detail below with reference to the attached drawing figures:

FIG. 1 is a block diagram illustrating an exemplary computing device suitable for use in connection with embodiments of the present invention;

FIG. 2 is a schematic diagram illustrating exemplary activity of a low engagement user, in accordance with an embodiment of the present invention;

FIG. 3 is a schematic diagram illustrating exemplary activity of a medium engagement user, in accordance with an embodiment of the present invention;

FIG. 4 is a schematic diagram illustrating exemplary activity of a high engagement user, in accordance with an embodiment of the present invention;

FIG. 5 is a schematic diagram illustrating exemplary advertisement interaction data, in accordance with an embodiment of the present invention;

FIG. 6 is a schematic diagram illustrating exemplary user engagement data, in accordance with an embodiment of the present invention;

FIG. 7 is a schematic diagram illustrating exemplary user engagement levels, in accordance with an embodiment of the present invention;

FIG. 8 is a flow diagram illustrating a method of assigning commercial values to users based on interactions of the users with a plurality of advertisements, in accordance with an embodiment of the present invention;

FIG. 9 is a flow diagram illustrating a method of delivering advertisements to users based on user engagement with advertisements, in accordance with an embodiment of the present invention;

FIG. 10 is a flow diagram illustrating an advertisement delivery auction, in accordance with an embodiment of the present invention; and

FIG. 11 is a flow diagram illustrating a method of improving the accuracy of an evaluated effectiveness of an advertisement based on user engagement levels, in accordance with an embodiment of the present invention.

### DETAILED DESCRIPTION

The subject matter of embodiments of the present invention is described with specificity herein to meet statutory requirements. Although the terms “step,” “block” and/or “module” etc. might be used herein to connote different components of methods or systems employed, the terms should not be interpreted as implying any particular order among or between various steps herein disclosed unless and except when the order of individual steps is explicitly described.

Embodiments of the present invention relate to systems, methods, and computer-storage media for analyzing user interactions with advertisements. In particular, methods are provided to evaluate preferences of particular users with respect to engaging with advertisements. In accordance with embodiments of the present invention, preferences of particular users with respect to engaging with advertisements are evaluated based on advertisement interaction data that is associated with a plurality of advertisements that have been presented to the particular users.

Advertisement interaction data includes information on how users interact with advertisements, and is generally used to evaluate the effectiveness of advertisements. For example, an advertisement platform host may present twenty different advertisements to a plurality of users. For purposes of discussion, the advertisements may be designated Ad1-Ad20. The effectiveness of each advertisement Ad1-Ad20 may be evaluated based on advertisement interaction data relating to advertisements Ad1-Ad20. In particular, advertisement interaction data may include information on the number of users who click an advertisement presented to them. This effectiveness metric that focuses on the probability that a user will click an advertisement is termed “p-click.” In particular, the p-click effectiveness metric represents the ratio of the number of users who click an advertisement to the number of users who are exposed to the advertisement. As discussed above, each time an advertisement is exposed to a user is referred to as an “impression.” For example, Ad5 and Ad6 may each be presented to 10,000 users. If Ad5 is clicked by 100 users, Ad5 would have a p-click of 1%. Further, if Ad6 is clicked by 10 users, Ad6 would have a p-click of 0.1%. Thus, based on the results from the basic p-click effectiveness metric, Ad5 would appear to be more effective than Ad6 at engaging users to click the advertisement.

However, evaluating an advertisement using the p-click effectiveness metric based only on a first-pass evaluation of advertisement interaction data fails to take into consideration preferences of particular users with respect to engaging with advertisements. For example, if each user of the audience of 10,000 users exposed to Ad5 usually has an average preference of clicking 5% of advertisements, then the 1% p-click effectiveness metric seems to indicate that Ad5 is less popular than other advertisements. Further, if each user of the audience of 10,000 users exposed to Ad6 usually has an average preference of clicking 0.01% advertisements, then the 0.1% p-click effectiveness metric seems to indicate Ad6 is at least as popular as other advertisements. As such, the p-click effectiveness measure of Ad6 is effectively penalized for being shown to a disproportionate number of low-engaging users, while the p-click effectiveness measure of Ad5 is deceptively high due to the disproportionately number of high-engaging users exposed to Ad5. In this way, it is seen how a p-click effectiveness metric may fail to take into consideration the user engagement preferences of users who are exposed to advertisements.

Accordingly, the evaluation of the effectiveness of an advertisement may be improved by analyzing the influence of preferences of particular users with respect to engaging with advertisements on the calculation of the p-click effectiveness metric. For this analysis, preferences of particular users with respect to engaging with advertisements may be evaluated based on advertisement interaction data. As used herein, advertisement interaction data includes information relating to user interactions with advertisements. For instance, advertisement interaction data may include user identifiers of users exposed to at least one of a plurality of advertisements. The advertisement interaction data may further include the extent to which each user interacted with the at least one advertisement to which he was exposed. Advertisement interaction data may also include contextual information about the conditions under which each user was exposed to at least one advertisement of the plurality of advertisements. For instance, the advertisement interaction data may include the time of day the users were presented the at least one advertisement, the industry of the at least one advertisement presented to the users, etc. Using this information, the advertisement interaction data may be sorted based on user identifiers for a plurality of users who were exposed to the at least one of the plurality of advertisements. The sorted information may then be used to determine preferences of particular users with respect to engaging with advertisements.

The extent to which a particular user interacts with an advertisement may be referred to as the extent to which the particular user engages with the advertisement. As used herein, user engagement preferences include the tendency of a user to click an advertisement, the tendency of a user to simply ignore advertisements, the tendency of a user to engage in a transaction with a website associated with an advertisement, or any combination thereof. In embodiments, a user may be influenced to either purchase an item and/or service online, or may be influenced by an online advertisement to purchase an item and/or service offline.

For purposes of discussion of embodiments of the present invention, users are categorized as “low engagement” users, “medium engagement” users, and “high engagement” users. In particular, users who generally are passive to advertisements are referred to as “low engagement” users. Users who generally click advertisements, but generally do not engage in transactions with webpages associated with the advertisements, are referred to as “medium engagement” users. Further, users who click advertisements and result in a significant number of transactions with webpages associated with the advertisements are referred to as “high engagement” users. In embodiments, a user's engagement level may be based on an industry, time of day, or previous transactional history. For instance, a user may be classified as a high engaging user for advertisements in the car industry, but may be classified as a low engaging user for advertisements in the electronics industry. Further, users may be categorized as low engagement users in a particular industry as a default until the user has been exposed to a threshold number of advertisements in that industry. User engagement data may be evaluated based on advertisement interaction data. In particular, advertisement interaction data associated with a plurality of advertisements may be sorted based on user identifiers, as discussed above. By analyzing the behavior of users within the context of the advertisements to which they were exposed, conclusions may be drawn as to the general user preferences of users engaging with advertisements. Additionally, condition-specific user preferences of users engaging with advertisements may be determined based on contextual information provided in the user engagement data.

For example, information regarding user interactions with advertisements may show that the user has a tendency to click 10% of advertisements that he is shown. Further, the user engagement data may show that the user clicks 50% of advertisements that are associated with hockey. Alternatively, user engagement data may show that the user has a tendency to click 30% of advertisements that he is shown between 9 pm and 2 am, but only has a 4% click rate of advertisements that he is shown between 9 am and 2 pm. These indicators, and similar indicators, may be determined based on advertisement interaction data and may provide insight into the general and condition-specific user engagement levels of users.

Once preferences of particular users with respect to engaging with advertisements have been discerned, user engagement levels may be used to improve an advertisement effectiveness evaluation, such as a p-click effectiveness metric. In particular, a p-click effectiveness metric may be modified by adjusting the number of impressions for each advertisement. For example, if an advertisement is presented to a set of users containing more than a threshold number of low engaging users, the p-click associated with the advertisement may be increased. In particular, if an advertisement is shown to 10,000 users, of whom 6,000 are medium- or high-engaging users and 4,000 are low-engaging users, the impression value of the 4,000 low-engaging users may be decreased by a factor of 10 by multiplying the 4,000 by 0.1. As such, the adjusted total impression associated with the advertisement would equal 6,000+(4,000*0.1)=6,000+400=6,400 impressions. Since the p-click associated with an advertisement is based on the number of times an advertisement is clicked divided by the number of impressions associated with the advertisement, the decrease in the number of impressions increases the p-click effectiveness metric associated with the advertisement.

Similarly, if an advertisement is presented to a set of users containing more than a threshold number of high engaging users, the p-click associated with the advertisement may be decreased. In particular, if an advertisement is shown to 10,000 users, of whom 6,000 are medium- or low-engaging users and 4,000 are high-engaging users, the impression value of the 4,000 high-engaging users may be increased by a factor of 10 by multiplying the 4,000 by 10. As such, the adjusted total impression associated with the advertisement would equal 6,000+(4,000*10)=6,000+40,000=46,000 impressions. Since the p-click associated with an advertisement is based on the number of times an advertisement is clicked divided by the number of impressions associated with the advertisement, the decrease in the number of impressions decreases the p-click effectiveness metric associated with the advertisement.

In further embodiments of the present invention, commercial values may be assigned to users based on the preferences of particular users with respect to engaging with advertisements. A commercial value assigned to a user and/or a group of users may be dependent on the context of the advertisement to be presented to the user. Further, a commercial value assigned to a user may be influenced by a user engagement level of the user. For instance, companies wanting to maximize exposure of an advertisement may find low engagement users more commercially valuable than high engagement users. For example, a marketing firm may have a political advertisement that they would like to present to the highest number of people for the lowest cost. As such, the marking firm may prefer to target the political advertisement to low engagement users who would be less likely to click an advertisement, thus maximizing the number of people who are exposed to the political advertisement. Alternatively, other companies may place a high commercial value on high engagement users who are likely to click and be influenced by an advertisement to buy products based on the advertisement.

As discussed above, commercial values may also be assigned to a user based on the type of advertisement presented to the user. For example, a user who has shown a historical preference for Yankees advertisements over Mets advertisements may have a high commercial value relating to Yankees advertisements and a low commercial value relating to Mets advertisements, even though the same user may have a high overall commercial value with regard to baseball advertisements. Further, the fact that a user has purchased a type of item may actually lower the commercial value of the user regarding that item, at least for a period of time. For instance, a user who is looking to buy a home may have a high commercial value to an insurance company selling home insurance. Once the user has purchased home insurance, though, the commercial value of that user may be diminished based on the presumption that most home owners only own one home and may not need to purchase more insurance for the foreseeable future. Additionally, the fact that a user has failed to purchase an item, such as a car, may lower the commercial value of the user regarding associated items. For example, a company selling car accessories would likely associate a low commercial value with a user who doesn't have a car.

Additional embodiments provide methods for delivering advertisements to users who have met a threshold user engagement level, commercial value, or a combination of both. As discussed above, a commercial value may be assigned to each of the plurality of users based on each user's interaction with the at least one of the plurality of advertisements to which they were exposed. Further, a set of users may be defined based on similarity of commercial values. In response to an advertisement request to deliver an advertisement to a particular type of user, the advertisement may be delivered to the set of users.

Accordingly, in one embodiment, the present invention provides computer-storage media having computer-executable instructions embodied thereon that, when executed, perform a method of assigning commercial values to users based on interactions of the users with a plurality of advertisements. The method includes receiving advertisement interaction data associated with each of a plurality of advertisements. The advertisement interaction data may be sorted based on user identifiers for a plurality of users. Each user of the plurality of users may have been exposed to at least one of the plurality of advertisements. Further, a commercial value may be assigned to each user of the plurality of users. The commercial value may be based on each user's interaction with the at least one of the plurality of advertisements to which they were exposed. Additionally, a set of users may be defined based on similarity of commercial values of the users.

In another embodiment, the present invention provides computer-storage media having computer-executable instructions embodied thereon that, when executed, perform a method of delivering advertisements to users based on user engagement with advertisements. The method includes receiving, from an advertiser, a request for an advertisement to be presented to a set of users. The request may include a pre-determined user engagement level threshold for each of the set of users. User engagement levels of the set of users may be evaluated based on user interactions of the set of users with a plurality of advertisements. Further, a subset of the set of users may be determined, where the subset is based on the evaluated user engagement levels. In particular, the subset of users may be determined based on each user of the subset of users meeting the pre-determined user engagement level threshold. The pre-determined user engagement threshold may be provided by the advertiser. Once the subset of users has been determined, the advertisement may be presented to the subset of users.

A third embodiment of the present invention provides a method of improving the accuracy of an advertisement based on user engagement levels. The method includes receiving data representing an evaluated effectiveness of an advertisement based on user interactions with the advertisement. The engagement levels of users who interacted with the advertisement may be evaluated. The user engagement levels may be evaluated based on historical engagement levels of the users. To refine the evaluation of the user engagement levels, the evaluation may be limited to historical advertisements that are similar to the advertisement under consideration. Once the user engagement levels have been evaluated, a normalization factor of evaluated effectiveness may be determined based on the historical engagement of the users exposed to the advertisement. The evaluated effectiveness of the advertisement may then be adjusted based on the determined normalization factor.

Having described an overview of embodiments of the present invention, an exemplary operating environment suitable for implementing embodiments hereof is described below.

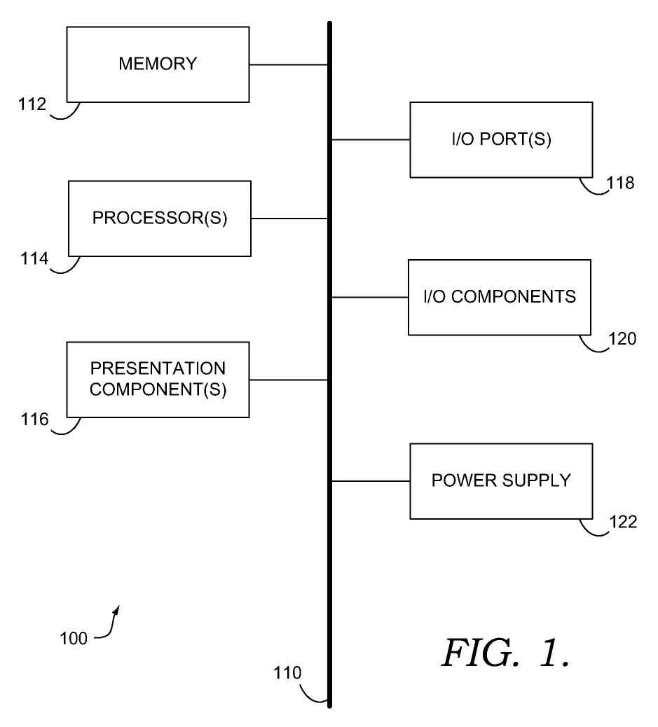

Referring to the drawings in general, and initially to FIG. 1 in particular, an exemplary computing device suitable for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of illustrated modules, components, or both.

Embodiments may be practiced in a variety of system configurations, including handheld devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “handheld device,” etc., as all are contemplated within the scope of FIG. 1 and reference to “computer” or “computing device.”

The computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or the I/O modules 120. The presentation module(s) 116 present data indications to a potential consumer or other device. Exemplary presentation modules include a display device, speaker, printing module, vibrating module, and the like. The I/O ports 118 allow computing device 100 to be logically coupled to other devices including the I/O modules 120, some of which may be built in. Illustrative modules include a microphone, joystick, game pad, satellite dish, scanner, printer, wireless device, and the like.

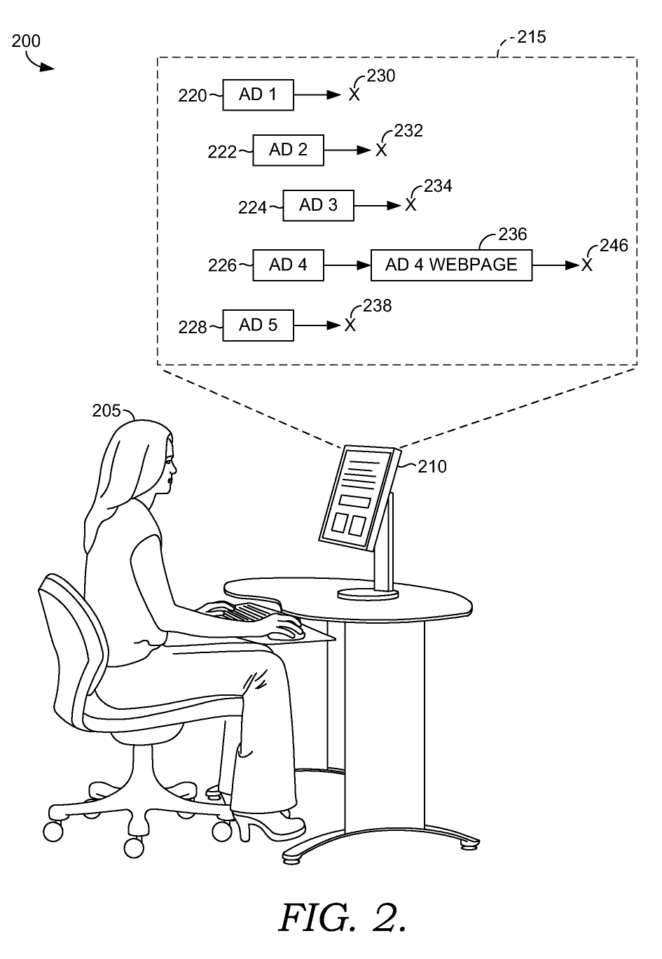

FIGS. 2-4 illustrate activities associated with different levels of user engagement with advertisements. As discussed above, user engagement is important to advertisement platform hosts because revenue from advertisement clicks is a significant source of revenue for advertisement platform hosts. As discussed above, user engagement preferences include the tendency of a user to click advertisements, the tendency of a user to simply ignore advertisements, and/or the tendency of a user to engage with a website associated with an advertisement. Additionally, a user's engagement preference with advertisements may depend on the advertisements presented to the user. For instance, a user who is presented an advertisement for soccer may almost always click the advertisement, while the user may completely ignore advertisements for ballet. Alternatively, a user may always ignore advertisements during a particular period of a day, such as while the user is at work. In this way, user engagement preferences may be condition- and/or advertisement-dependent.

FIG. 2 illustrates exemplary activity 200 of a low engagement user 205, in accordance with an embodiment of the present invention. Activity of a low engagement user may generally include little or no interaction, such as a click or transaction, between the user and advertisements presented to the user. As seen in FIG. 2, user 205 is presented with advertisements 220, 222, 224, 226, and 228 on a computing screen 210. An enlarged screen 215 is shown to better illustrate advertisements 220-228. As seen on enlarged screen 215, advertisements 220-228 may be ignored 230, 232, 234, and 238 by user 205. Alternatively, advertisements 220-228 may be clicked by user 205 to progress to an advertisement webpage 236. In displayed activity 200, user 205 has ignored 230, 232, 234, and 238 four out of five advertisements 220, 222, 224, and 228. Further, after clicking the fifth advertisement 226 to progress to a website 236 associated with advertisement 226, user 205 failed to engage in a transaction on conversion page 246. In alternative embodiments, as provided below, user 205 may purchase an item from a webpage associated with one of advertisements 220-228.

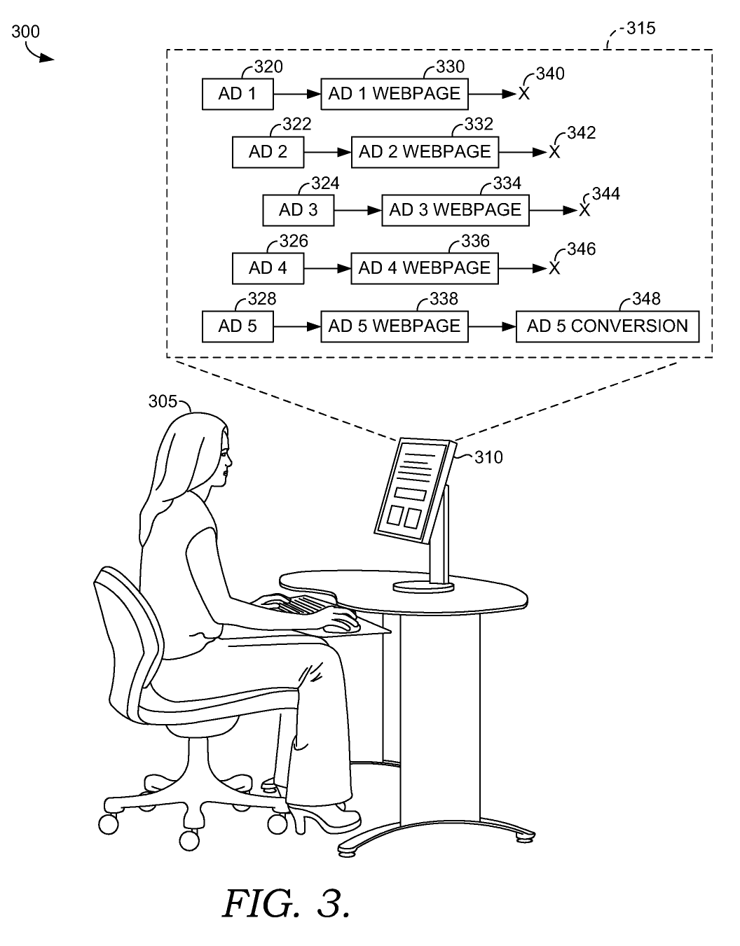

FIG. 3 illustrates exemplary activity 300 of a medium engagement user 305, in accordance with an embodiment of the present invention. Activity of a medium engagement user may generally include a user clicking advertisements, but initiating few if any transactions with a website associated with the advertisement. As seen in FIG. 3, user 305 is presented with advertisements 320 on a computing screen 310. An enlarged screen 315 is shown to better illustrate advertisements 320, 322, 324, 326, and 328. As seen on enlarged screen 315, advertisements 320-328 may be clicked by user 305 to progress to a webpage 330, 332, 334, 336, and 338 associated with each advertisement 320, 322, 324, 326, and 328, respectively. In displayed activity 300, user 305 has clicked all five advertisements 320-328 to progress to a webpage 320, 322, 324, 326, and 338. However, in four out of five of webpages 330, 332, 334, 336, and 338, user 305 has failed to complete a transaction. Rather, user 305 has ignored 340, 342, 344, and 346 four out of five webpages 330, 332, 334, and 336. Further, user 305 engaged in a transaction to purchase an item from the fifth webpage 338. In this way, user 305 has generally acted as a medium engagement user, since user 305 generally clicked advertisements presented to him, but generally did not ultimately purchase items based on the advertisements 330-338.

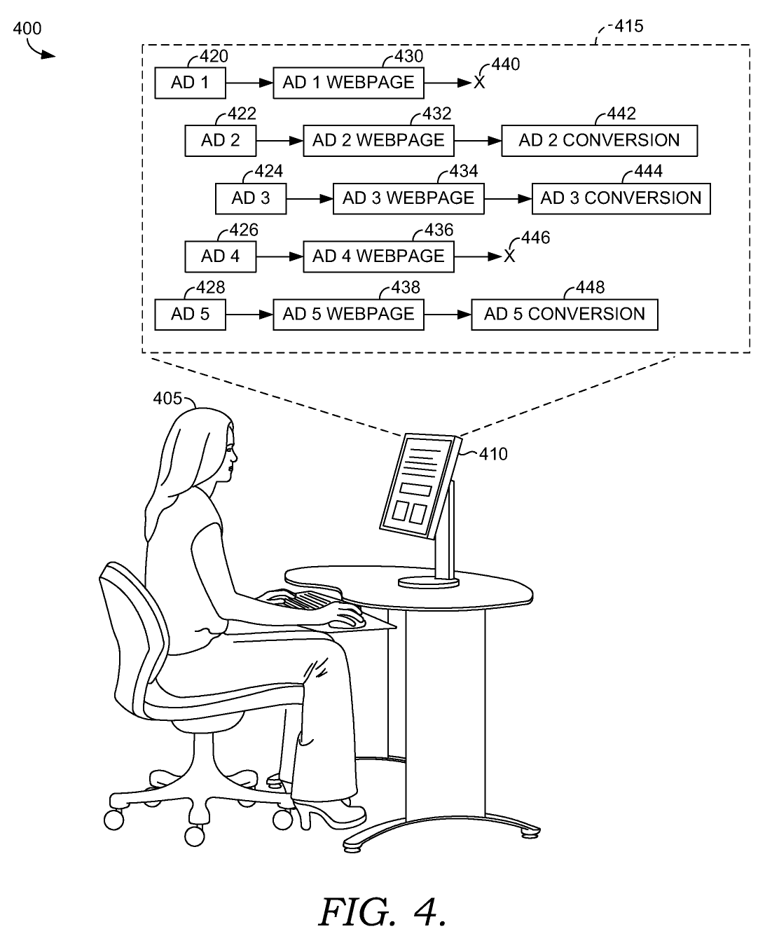

FIG. 4 illustrates exemplary activity 400 of a high engagement user 405, in accordance with an embodiment of the present invention. Activity of a high engagement user may generally include a user clicking advertisements and, further, making a significant number of purchases based on the advertisements. As seen in FIG. 4, user 405 is presented with advertisements 420, 422, 424, 426, and 428 on a computing screen 410. An enlarged screen 415 is shown to better illustrate advertisements 420-428. As seen on enlarged screen 415, advertisements 420-428 may be clicked by user 405 to progress to a webpage 430, 432, 434, 436, and 438 associated with each advertisement 420, 422, 424, 426, and 428, respectively. In displayed activity 400, user 405 has clicked all five advertisements 420-428 to progress to webpages 430-438. Further, user 405 has purchased 442, 444, and 448 three out of five items based on advertisements 420-428. While user 405 has ignored 440 and 446 two web pages 430 and 436, respectively, a buying rate of 60% may be deemed a high enough threshold to regard user 405 as a high engagement user.

A medium engagement user may differ from a high engagement user based on 1) the number of purchases that have been made by the user and 2) the definition of what constitutes a threshold number of purchases made by a medium engagement user versus a high engagement user. For instance, in FIG. 3 above, the user made one purchase out of five advertisements that were clicked. While only one purchase was made, a buying ratio of 20% may meet a minimum purchasing threshold to consider the user in FIG. 3 a high engagement user. In alternative embodiments, a medium engaging user may be presented with 300 advertisements, of which the user clicks 20% and ultimately makes a purchase based on one advertisement. In this case, the propensity of the user to click 20% of advertisements may be considered medium engagement, as the user is interacting with a significant number of advertisements by clicking the advertisements. Further, medium engagement users may be distinguished from low engagement users if the medium engagement users have made at least one purchase. On this point, it may be beneficial to distinguish between users who have not purchased an item using the internet and users who have made at least one purchase using the internet. Additionally, it may be beneficial to distinguish users based on their user engagement level in a particular industry. In particular, advertisers may target users who are high-engaging users in the advertiser's industry, even if the users are not otherwise high-engaging users. For example, an electronics advertiser may wish to target users who, while generally low-engaging, are high-engaging with respect to advertisements.

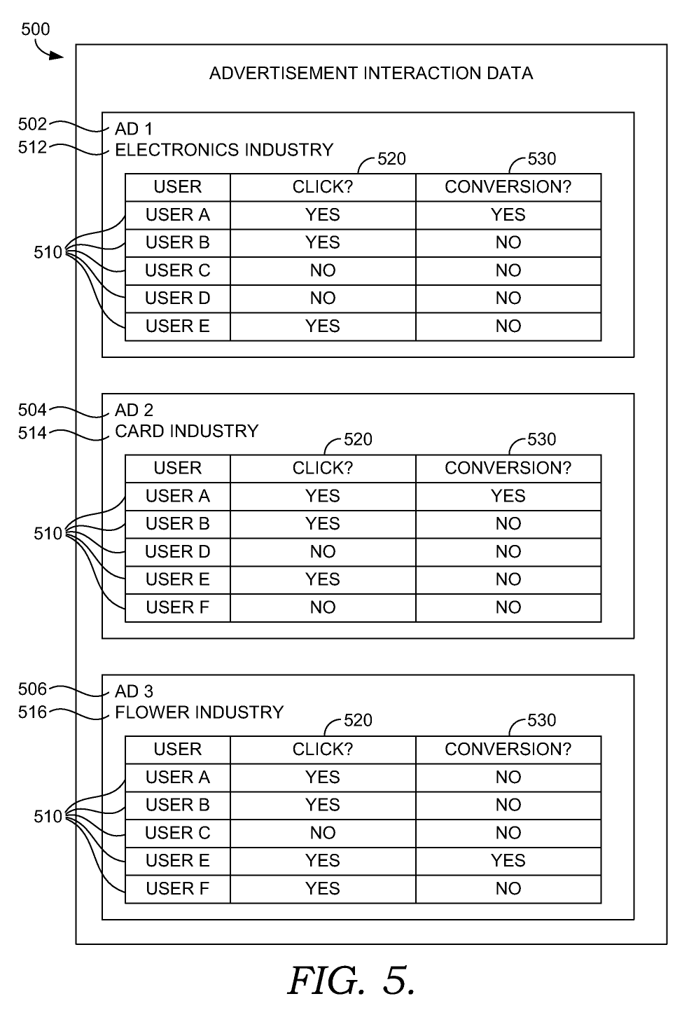

As discussed above, user engagement levels may be evaluated based on advertisement interaction data. FIG. 5 illustrates exemplary advertisement interaction data 500, in accordance with an embodiment of the present invention. In particular, FIG. 5 illustrates advertisement interaction data 500 detailing user interactions with advertisements 502, 504, and 506. Users 510 are designated as A-F. As seen in FIG. 5, the industry 512, 514, and 516 of advertisements 502, 504, and 506 is provided. In particular, advertisement 502 has an industry 512 of Electronics advertisements; advertisement 504 has an industry 514 of Card advertisements; and advertisement 506 has an industry 516 of Flower advertisements. In embodiments, advertisement interaction data 500 may be filtered based on a type of advertisement. Further, for each advertisement 502, 504, and 506, information may be provided as to how each user 510 exposed to the advertisement has interacted with the advertisement. In particular, information may be provided as to whether each user clicked 520 each advertisement and/or whether each user engaged in a conversion 530 with a webpage associated with each advertisement. In accordance with embodiments of the present invention, advertisement interaction data 500 may be sorted based on user identifiers to generate user engagement data.

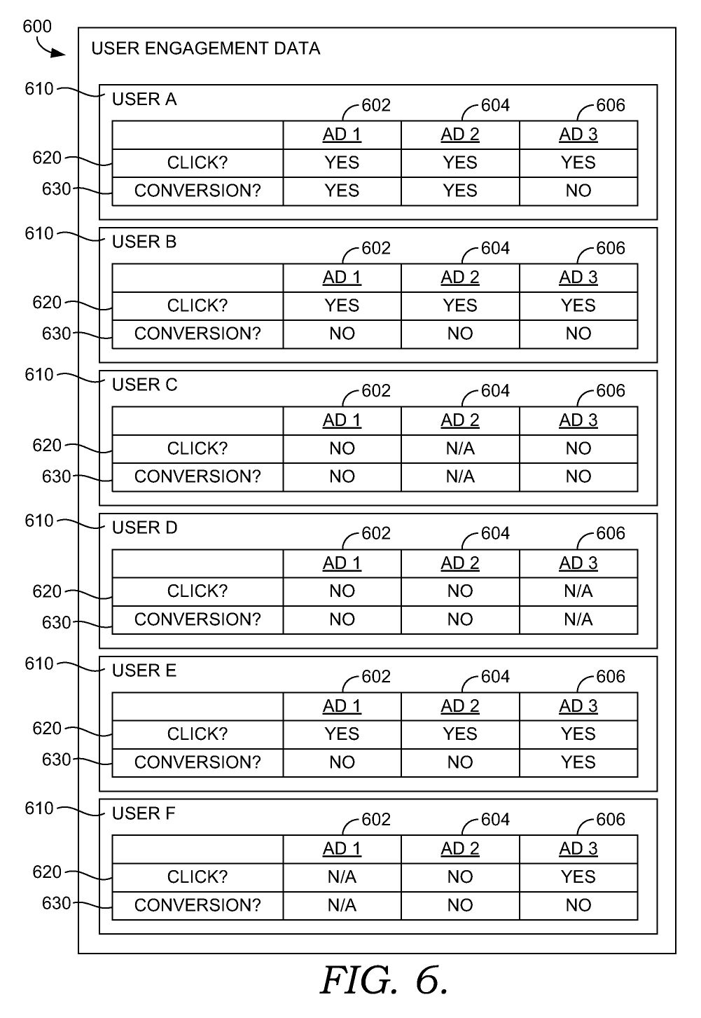

An example of advertisement interaction data that has been sorted to illustrate user interactions with advertisements is shown in FIG. 6. FIG. 6 illustrates exemplary user engagement data 600, in accordance with an embodiment of the present invention. In particular, user engagement data 600 is generated based on sorting advertisement interaction data 500 based on user identifiers. As such, user engagement data 600 illustrates user engagement preferences for users 610 with regard to advertisements 602, 604, and 606. Advertisements 602, 604, and 606 correlate to advertisements 502, 504, and 506 in FIG. 5, respectively. Further, users 610 are designated as A-F. In particular, user engagement data 600 includes information relating to whether each user clicked 620 each advertisement and/or whether each user purchased 630 an item and/or service based on each advertisement.

For example, User A is shown to have clicked 620 each advertisement 602, 604, and 606 presented to her. Further, User A is shown to have engaged in a conversion with a webpage associated with each of advertisements 602 and 604. As discussed above, 602 and 604 are Electronics and Card advertisements, respectively, whereas advertisement 606 is a Flower advertisement. Based on this information, a conclusion might be drawn that User A is generally a high engaging user, though her high engaging behavior may be industry-specific. Further, User B is shown to have clicked 620 each of advertisements 602, 604, and 606, but is not shown to have made any transactions based on the advertisement interaction data. As such, User B may be considered a medium engaging user. In contrast, User C is shown to have failed to click any advertisement. As such, user C may be considered a low engaging user.

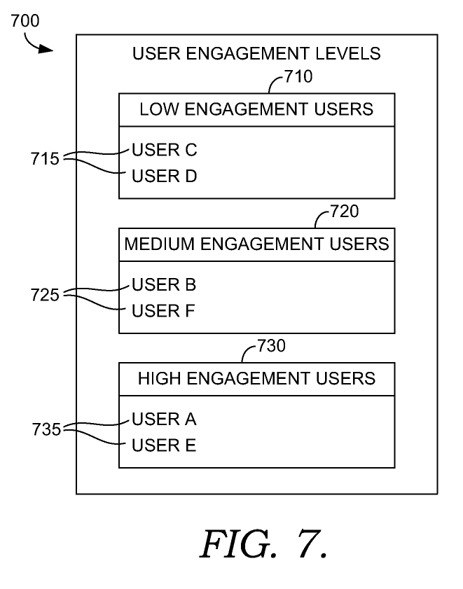

FIG. 7 illustrates exemplary user engagement levels 700, in accordance with an embodiment of the present invention. User engagement levels 700 of users are based from user engagement data, such as user engagement data 600 as seen in FIG. 6. In particular, user engagement levels of FIG. 7 include low engagement users 710, medium engagement user 720, and high engagement users 730. Further, Users 710 are designated as A-F. As illustrated in FIG. 7, Users C and D are low engagement users 715. Both Users C and D failed to click any advertisement presented to them. As such, they did not interact with an advertisement, which is in accordance with low engagement user behavior. Additionally, Users B and F are designated medium engagement users 725. Both Users B and F clicked at least one advertisement presented to them, but neither user engaged in a conversion with a webpage associated with an advertisement. As such, they interacted with at least one advertisement but did not make a transaction, which is in accordance with medium engagement user behavior. Further, Users A and E are designated high engagement users 735. Both Users A and E clicked each advertisement presented to them, and each user engaged in a transaction with a webpage associated with each advertisement. As such, they interacted with advertisements and made transactions, which is in accordance with high engagement user behavior.

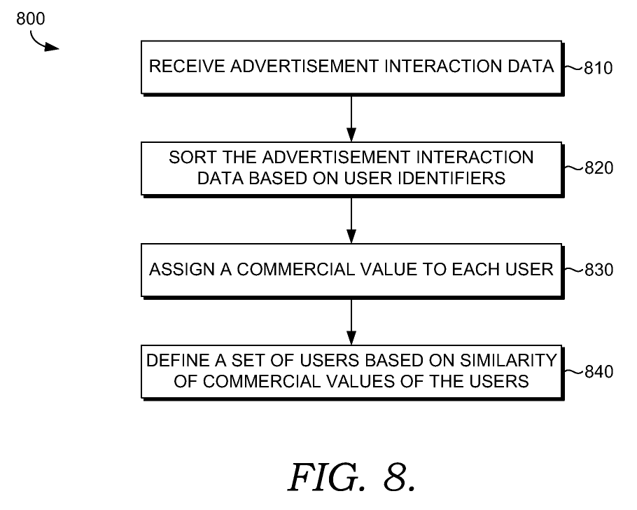

FIG. 8 is a flow diagram 800 illustrating a method of assigning commercial values to users based on interactions of the users with a plurality of advertisements, in accordance with an embodiment of the present invention. As discussed above, user interactions with advertisements may be determined based on advertisement interaction data. Accordingly, as indicated at block 810, advertisement interaction data associated with each of a plurality of advertisements is received. In order to determine user interactions with the plurality of advertisements, at block 820, the advertisement interaction data is sorted based on user identifiers for a plurality of users. Each of the plurality of users has been exposed to at least one of the plurality of advertisements.

In embodiments, a user identifier may be associated with an online account of a user, such as an e-mail account or a social-networking account. In this way, the advertisements that have been shown to a user may be distinguished based on the account of the user who was exposed to the advertisements. The information regarding the interaction of a user with advertisements may also be stored in accordance with the user's personal identifier. Further, while a user identifier may also refer to a general reference identifier such as an IP address, the association of a user identifier with an online account may allow for the tracking of multiple user preferences from a single computing IP address identifier. In this way, a four-member family with distinct individual e-mail accounts may be analyzed as four different users with four distinct sets of preferences rather than one single IP address-based user who has a myriad of four different types of preferences. Further, the tracking of an individual user may be enabled based on the access that a social networking platform manager has to the preferences of the individual account users.

Once the advertisement interaction data has been sorted based on the user identifiers, at block 830 a commercial value is assigned to each user of the plurality of users. The assignment of a commercial value may be based on each user's interaction with the at least one of the plurality of advertisements to which they were exposed. In embodiments, each user of the plurality of users may be assigned a user engagement level based on the interactions of each user with the at least one of the plurality of advertisements to which they were exposed. However, it is also within the scope of embodiments of the present invention that a commercial value may be assigned to one or more users independent of user engagement levels. For instance, a certain commercial value may be assigned to each user based on a user having made at least one online purchase. While this factor of purchasing at least one item online may also be considered in assigning user engagement levels, the criteria for assigning a commercial value may be distinct from the criteria of determining a user engagement level.

Further, commercial values may be further based on characteristics of a user and/or advertisement campaign for which the commercial values may be assigned. For example, commercial values may be assigned and/or amended based on a user's preference of clicking advertisements. Alternatively, a user's preference for viewing advertisements at a particular point of a day may increase the relative value of the commercial value of that user during that period of the day. Once commercial values have been assigned to each user of the plurality of users, a set of users may be determined based on similarity of commercial values assigned to the users. Additionally, once a set of users has been determined based on similarity of commercial values, advertisements may be targeted to the set of users based on the commercial value(s) associated with the set of users.

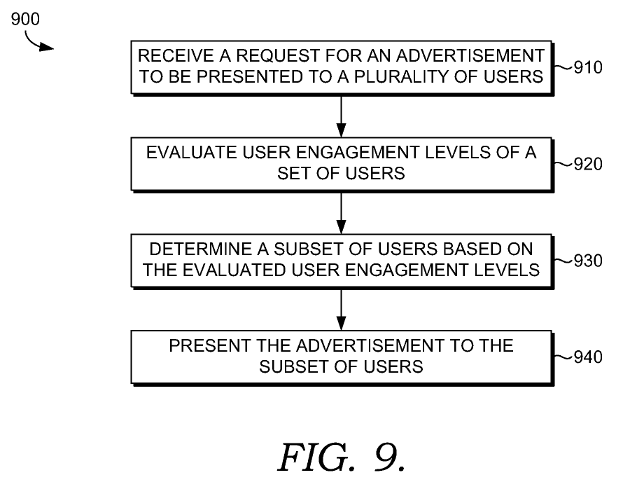

FIG. 9 is a flow diagram illustrating a method 900 of delivering advertisements to users based on user engagement with advertisements, in accordance with an embodiment of the present invention. As indicated at block 910, a request for an advertisement to be presented to a set of users is received. The request may be received from an advertiser. Further, the request may contain a pre-determined user engagement threshold that the set of users must meet. Alternatively, an advertiser may choose a particular advertising platform host based on limitations of the advertisement platform host that require a pre-determined user engagement threshold of its users before the set of users is presented the advertisement. The pre-determined user engagement level threshold may comprise a minimum level of engagement. Alternatively, the pre-determined user engagement level threshold may comprise a maximum level of engagement. At block 920, user engagement levels of the set of users are evaluated based on user interactions of the set of users with a plurality of advertisements. Further, at block 930, a subset of the set of users is determined based on the evaluated user engagement levels, where each user of the subset of users meets the pre-determined user engagement level threshold.

In embodiments, the pre-determined user engagement level threshold may be used to target advertisements to users who meet the threshold. For example, if an advertiser wanted to maximize the exposure of the user to an advertisement, the advertiser may target users who have a maximum pre-determined user engagement level threshold. In this way, the advertiser may target users who have a low engagement level such that a low number of users will click the advertisement. Alternatively, if an advertiser wanted to maximize the number of purchases that result from users clicking an advertisement, the advertiser may target users who have a minimum pre-determined user engagement level threshold. In this way, the advertiser may set a minimum user engagement level threshold to ensure users exposed to the advertisement have a preference of making purchases online. In further embodiments, the pre-determined user engagement level threshold may be condition-specific. For example, an advertiser may request that the set of users meet a pre-determined user engagement level threshold within the industry of the advertiser. As such, users who may have a strong preference for products online generally, but who lack a strong preference for buying producing online in the industry of the advertiser, may be filtered out of the set of users. At block 940, the advertisement is presented to the subset of users.

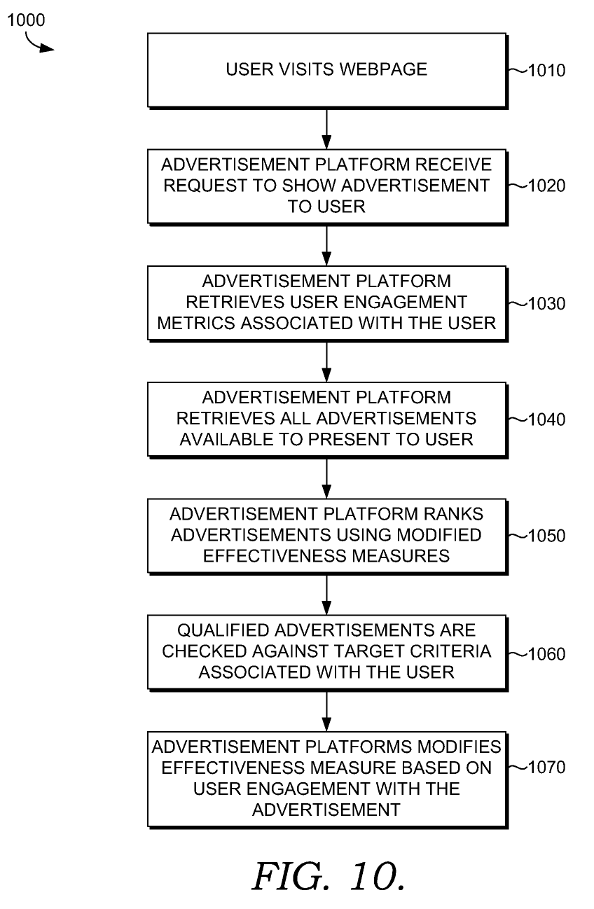

FIG. 10 is a flow diagram 1000 illustrating an advertisement delivery auction, in accordance with an embodiment of the present invention. At block 1010, a user visits a webpage. In alternative embodiments, the user may initiate a search query or retrieve e-mail from his account. Further, the user may generate a request for an advertisement. At block 1020, an advertisement platform receives the request for an advertisement. Further, the advertisement platform identifies the user. In particular, the advertisement platform may identify the user based on information in the request for the advertisement. At block 1030, the advertisement platform queries a database to identify advertisement engagement metrics associated with the user. The advertisement engagement metrics may include information categorized by industry, time of day, time of year, etc.

At block 1040, an advertisement platform retrieves all advertisements that may be presented to the user. For example, a particular webpage may have 2,000 advertisements available for placement on the webpage. Additionally, at block 1050, the advertisement platform ranks the advertisements based on advertisement criteria, such as bid amount of the advertisement, relevancy of the advertisement to the user, and p-click effectiveness metric associated with the advertisement. In particular, the p-click effectiveness metric may be modified in accordance with embodiments of the present invention. At block 1060, a set of advertisements that qualify for placement on the webpage are analyzed based on target criteria provided by the advertisers. The target criteria, which provides demographics of a target audience for the advertisement, may be analyzed against the user metrics. At block 1070, the advertisement platform modifies the p-click effectiveness metric for an advertisement based on user interaction with the advertisement. Further, user engagement metrics, such as commercial value, engagement level, etc., may also be modified based on the user interaction with the advertisement.

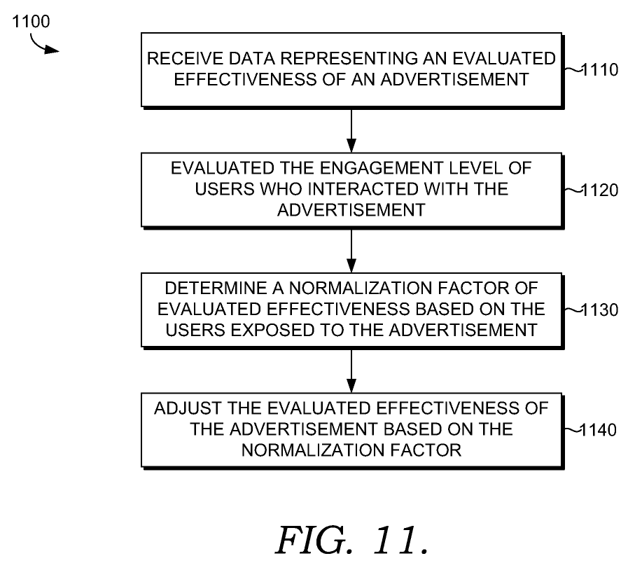

FIG. 11 is a flow diagram 1100 illustrating a method of improving the accuracy of an evaluated effectiveness of an advertisement based on user engagement levels, in accordance with an embodiment of the present invention. As indicated at block 1110, data representing an evaluated effectiveness of an advertisement based on user interactions with the advertisement is received. As discussed above, an evaluated effectiveness of an advertisement may include a p-click effectiveness metric. The p-click effectiveness metric may be based on advertisement interaction data associated with a plurality of advertisements that, further, may be used to generate user engagement data outlining user interactions associated with the plurality of advertisements. However, methods of evaluating advertisement effectiveness fail to consider user engagement levels of users exposed to advertisements.

In order to consider user engagement levels in improving an effectiveness factor, the engagement levels of users who were presented the advertisements are evaluated at block 1120. In particular, the historical user engagement levels of the users exposed to the advertisement are evaluated. In embodiments, the historical user engagement levels of the users exposed to the advertisement may be filtered to include only advertisements similar to the advertisement being evaluated. In further embodiments, historical advertisements may be filtered to focus on advertisements presented at the same time of day or during the same time of year as the advertisement being evaluated.

Based on the historical user engagement data, a normalization factor of evaluated effectiveness is determined at block 1130. For example, for an audience of 10,000 users who were exposed to an advertisement, a calculation may be made as to how many users are historically low engaging users. A threshold percentage of low engaging users may then be set, with an adjustment factor increasing the advertisement effectiveness evaluation by an incremental amount for each user that is above the threshold number of users. Further, at block 1040, the evaluated effectiveness of the advertisement is adjusted. The adjustment of the evaluated effectiveness may be based on the determined normalization factor.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. Computer-storage media having computer-executable instructions embodied thereon that, when executed, perform a method of assigning commercial values to users based on interactions of the users with a plurality of advertisements, the method comprising:
receiving advertisement interaction data associated with each of the plurality of advertisements;
sorting the advertisement interaction data based on user identifiers for a plurality of users, each user having been exposed to at least one of the plurality of advertisements;
assigning a commercial value to each user of the plurality of users based on each user's interaction with the at least one of the plurality of advertisements to which they were exposed; and
defining a set of users based on similarity of commercial values of the users.

2. The computer-storage media of claim 1, wherein the assigned commercial value is based on an industry of a presented advertisement.

3. The computer-storage media of claim 1, wherein the assigned commercial value is based on a time of day an advertisement is presented.

4. The computer-storage media of claim 1, wherein the method further comprises:
targeting advertisements to the set of users based on the similarity of commercial values of the users.

5. The computer-storage media of claim 1, wherein advertisement interaction data comprises at least one of an advertiser identifier, a user identifier of a user presented at least one advertisement, an indication of user action in response to a presentation of an advertisement, a time of day an advertisement is presented, and an industry of a presented advertisement.

6. The computer-storage media of claim 5, wherein the method further comprises:
targeting advertisements to the set of users based on the industry of the advertisement presented to the user.

7. Computer-storage media having computer-executable instructions embodied thereon that, when executed, perform a method of delivering advertisements to users based on user engagement with advertisements, the method comprising:
receiving, from an advertiser, a request for an advertisement to be presented to a set of users, each user meeting a pre-determined user engagement level threshold;
evaluating user engagement levels of the set of users based on user interactions of the set of users with a plurality of advertisements;
determining a subset of the set of users based on the evaluated user engagement levels, wherein each user of the subset of users meets the pre-determined user engagement level threshold; and
presenting the advertisement to the subset of users.

8. The computer-storage media of claim 7, wherein each user of the set of users has made at least one online purchase.

9. The computer-storage media of claim 7, wherein the user interactions of the set of users are determined based on advertisement interaction data sorted according to user identifiers.

10. The computer-storage media of claim 7, wherein the pre-determined user engagement level threshold is provided by the advertiser.

11. The computer-storage media of claim 7, wherein the pre-determined user engagement level threshold comprises a minimum threshold of user engagement activity.

12. The computer-storage media of claim 7, wherein the pre-determined user engagement level threshold comprises a maximum threshold of user engagement activity.

13. The computer-storage media of claim 11, wherein the method further comprises:
targeting advertisements to the subset of users based on the pre-determined user engagement level threshold to maximize user clicks of advertisements.

14. The computer-storage media of claim 12, wherein the method further comprises:
targeting advertisements to the subset of users based on the pre-determined user engagement level threshold to minimize user clicks of advertisements.

15. A method of improving the accuracy of an evaluated effectiveness of an advertisement based on user engagement levels, the method comprising:
receiving data representing an evaluated effectiveness of an advertisement based on user interactions with the advertisement;
evaluating the engagement level of users who interacted with the advertisement based on historical engagement levels of the users;
determining a normalization factor of evaluated effectiveness based on the historical engagement of the users exposed to the advertisement; and
adjusting the evaluated effectiveness of the advertisement based on the determined normalization factor.

16. The method of claim 15, wherein the evaluated effectiveness of an advertisement is measured using a p-click effectiveness metric.

17. The method of claim 15, wherein the historical engagement of the users is based on advertisements similar to the evaluated advertisement.

18. The method of claim 15, wherein user interactions are determined based on advertisement interaction data.

19. The method of claim 15, wherein adjusting the evaluated effectiveness of the advertisement comprises increasing the evaluated effectiveness of the advertisement based on a number of low engagement users exceeding a threshold number of low engagement users.

20. The method of claim 15, wherein adjusting the evaluated effectiveness of the advertisement comprises decreasing the evaluated effectiveness of the advertisement based on a number of high engagement users exceeding a threshold number of high engagement users
